(19) United States
(12) Patent Application Publication
(10) Pub. No.: US 2023/0318027 A1
(43) Pub. Date: Oct. 5, 2023

(54) ELECTRODE MATERIAL MIXTURE SLURRY, SOLID-STATE CELL ELECTRODE AND SOLID-STATE CELL

(71) Applicant: HONDA MOTOR CO., LTD., Tokyo (JP)

(72) Inventors: Pu QIAN, Saitama (JP); Akihiro YOSHIZAWA, Saitama (JP); Wataru SHIMIZU, Saitama (JP); Atsushi OGAWA, Saitama (JP)

(21) Appl. No.: 18/181,562

(22) Filed: Mar. 10, 2023

(30) Foreign Application Priority Data
Mar. 29, 2022 (JP) 2022-054079

(51) Int. Cl. H01M 10/0562; H01M 4/62

(52) U.S. Cl. CPC H01M 10/0562; H01M 4/622; H01M 2300/0068

(57) ABSTRACT

To provide an electrode material mixture slurry which can enhance the uniformity of electrode materials in a solid-state cell and obtain a preferred mechanical strength of an electrode layer that is formed. An electrode material mixture slurry for manufacturing a solid-state cell electrode, comprising: a solid electrolyte, an electrode active material, a binder, and a solvent, the solid electrolyte being at least one of a sulfide or an oxide, the binder being a polymer binder which includes an unsaturated carbon-carbon bond.

This application is based on and claims the benefit of priority from Japanese Patent Application No. 2022-054079, filed on 29 Mar. 2022, the content of which is incorporated herein by reference.

### BACKGROUND OF THE INVENTION

### Field of the Invention

The present invention relates to electrode material mixture slurries, solid-state cell electrodes and solid-state cells.

### Related Art

In recent years, electrical and electronic devices of various sizes for automobiles, personal computers, cell phones and the like have been widely used, and thus demand for high-capacity, high-output cells has been growing rapidly. The development of higher-performance cells is also important in terms of continuing and realizing efforts for alleviating or reducing the impact of climate change. Among various types of cells, solid-state cells have attracted particular attention because they are superior in that solid electrolytes are nonflammable to enhance safety and higher energy densities.

Since in the electrode of a solid-state cell, the surfaces of an electrode active material and a solid electrolyte have a high polarity, it is difficult to obtain, by kneading, a slurry in which they are uniformly mixed with each other. Hence, in order to obtain a slurry in which electrode materials are uniformly mixed with each other, an attempt has been made to suppress an oxidation reaction at an interface between an electrode active material and a solid electrolyte, and an attempt has been made to mix a small amount of oxide in a solid electrolyte made of a sulfide to suppress the oxidation of the solid electrolyte.

Patent Document 1 proposes a technique in which in an electrode layer material including an inorganic solid electrolyte, a surface modifier and an active material, a binder, a surface modification agent or a surface modifier that functions as a dispersion medium is added to a solid electrolyte composition, thus the active material and the inorganic solid electrolyte are satisfactorily dispersed by the interaction of the surface modifier to achieve a uniform distribution and consequently, the output of an all-solid-state secondary cell is enhanced.

Patent Document 1: PCT International Publication No. WO2018/047946

### SUMMARY OF THE INVENTION

In the current state of the technique disclosed in Patent Document 1, while the uniformity of the active material and the solid electrolyte can be achieved, the mechanical strength of an electrode layer which is formed is not sufficiently considered. A solid-state cell is required to apply a sufficient surface pressure to the cell so that input/output characteristics are prevented from being lowered by an increase in interface resistance, and thus it is important to enhance the mechanical strength of an electrode layer.

The present invention is made in view of the foregoing, and an object of the present invention is to provide an electrode material mixture slurry which can enhance the uniformity of electrode materials in a solid-state cell and obtain a preferred mechanical strength of an electrode layer that is formed.

(1) A first aspect of the present invention relates to an electrode material mixture slurry for manufacturing a solid-state cell electrode, the electrode material mixture slurry including: a solid electrolyte, an electrode active material, a binder, and a solvent, the solid electrolyte being at least one of a sulfide or an oxide, the binder being at least one of a polymer binder that includes an unsaturated carbon-carbon bond or a polymer binder that includes an electron donating group.

(2) A second aspect of the present disclosure relates to the electrode material mixture slurry as described in the first aspect, further including a surface modifier that modifies the surface of at least one of the solid electrolyte or the electrode active material.

(3) A third aspect of the present disclosure relates to the electrode material mixture slurry as described in the second aspect, in which the surface modifier is a copolymer, and in the copolymer, the content of a repeating unit including a predetermined functional group is less than 10 mol %.

(4) A fourth aspect of the present disclosure relates to the electrode material mixture slurry as described in the third aspect, in which the copolymer is used as the binder.

(5) A fifth aspect of the present disclosure relates to the electrode material mixture slurry as described in the third or fourth aspect, in which, in the copolymer, the content of the repeating unit including a predetermined functional group is equal to or greater than 1 mol % and less than 8 mol %.

(6) A sixth aspect of the present disclosure relates to the electrode material mixture slurry as described in the fifth aspect, in which, in the copolymer, the content of the repeating unit including a predetermined functional group is equal to or greater than 2 mol % and less than 5 mol %.

(7) A seventh aspect of the present disclosure relates to the electrode material mixture slurry as described in any one of the third to sixth aspects, in which the predetermined functional group is at least one functional group selected from the group consisting of an ester group, a carboxylate salt group, a sulfonate salt group, a nitrile group, an ether group and a phosphate salt group.

(8) An eighth aspect of the present disclosure relates to a solid-state cell electrode including: an electrode layer that includes a solid electrolyte, an electrode active material, and a binder, the binder being at least one of a polymer binder that includes an unsaturated carbon-carbon bond or a polymer binder that includes an electron donating group, the solid electrolyte being at least one of a sulfide or an oxide, the electrode layer including a covalent bond or a coordinate bond formed between the binder and at least one of the solid electrolyte or the electrode active material.

(9) A ninth aspect of the present disclosure relates to a solid-state cell including the solid-state cell electrode as described in the eighth aspect.

According to the present invention, it is possible to provide an electrode material mixture slurry which can enhance the uniformity of electrode materials in a solid-state cell and obtain a preferred mechanical strength of an electrode layer that is formed.

### BRIEF DESCRIPTION OF THE DRAWINGS

FIG. 1 is a TOF-SIMS image of a positive electrode layer and a solid electrolyte layer formed of an electrode material mixture slurry according to Example of the present invention;

FIG. 2 is a diagram showing IR spectra when an electrode layer is formed of an electrode material mixture slurry according to Example of the present invention; and

FIG. 3 is a diagram showing IR spectra when an electrode layer is formed of an electrode material mixture slurry according to Example of the present invention.

### DETAILED DESCRIPTION OF THE INVENTION

### Electrode Material Mixture Slurry

An electrode material mixture slurry according to the present embodiment is an electrode material mixture slurry for manufacturing of a solid-state cell electrode, and includes a solid electrolyte, an electrode active material, a binder and a solvent. The binder is a polymer binder which includes an unsaturated carbon-carbon bond, the polymer binder is included in the electrode material mixture slurry and thus it is possible to enhance the mechanical strength of an electrode layer formed of the electrode material mixture slurry. In addition, a surface modifier is preferably included in the electrode material mixture slurry, and the surface of the polymer binder is modified by the solvent or the surface modifier. In this way, it is possible to uniformize the electrode material mixture slurry.

(Solid Electrolyte)

The solid electrolyte has charge transfer medium conductivity. In the present embodiment, the solid electrolyte is one of a sulfide solid electrolyte and an oxide solid electrolyte. As the solid electrolyte, the sulfide solid electrolyte is preferable because the sulfide solid electrolyte has higher charge transfer medium conductivity and can form a chemical bond with the binder which will be described later. The surface of the solid electrolyte is preferably modified by the surface modifier which will be described later.

[Sulfide Solid Electrolyte]

The sulfide solid electrolyte contains, for example, a metal element (M) and sulfur (S). Examples of the metal element (M) can include Li, Na, K, Mg, Ca and the like. In the following description of the present embodiment, the charge transfer medium may be a Li ion, and the metal element (M) may be Li. In addition to Li and sulfur (S), the sulfide solid electrolyte in the present embodiment preferably contains an element A (A is at least one type selected from the group consisting of P, Si, Ge, Al and B). The element A is preferably P (phosphorus). Furthermore, in terms of enhancing Li ion conductivity, the sulfide solid electrolyte may contain a halogen element such as Cl, Br or I. The sulfide solid electrolyte may contain O (oxygen). The sulfide solid electrolyte preferably has an aldirodite-type crystal structure.

Specific examples of the sulfide solid electrolyte can include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers and Z is any one of Ge, Zn or Ga), Li₂S—GeS₂, Li₂S—SiS₂—Li₃PO₄, Li₂S—SiS₂—LiₓMO_{y} (where x and y are positive numbers and M is any one of P, Si, Ge, B, Al, Ga and In) or the like. The “Li₂S—P₂S₅” or the like described above means a sulfide solid electrolyte which is formed of a raw material composition including Li₂S and P₂S₅. The same is true for the other similar descriptions.

The sulfide solid electrolyte may be a sulfide glass or a crystallized sulfide glass, and may be a crystalline material obtained by a solid-phase method. The sulfide glass can be obtained, for example, by performing mechanical milling (such as ball mill) on a raw material composition. The crystallized sulfide glass can be obtained, for example, by performing heat treatment on the sulfide glass at a temperature equal to or greater than a crystallization temperature.

The Li-ion conductivity of the sulfide solid electrolyte at room temperature is, for example, preferably equal to or greater than 1×10⁻⁴ S/cm, and more preferably equal to or greater than 1×10⁻³ S/cm.

[Oxide Solid Electrolyte]

Examples of the oxide solid electrolyte material can include a NASICON-type oxide, a garnet-type oxide, a perovskite-type oxide and the like. Examples of the NASICON-type oxide can include oxides (such as Li_{1.5}Al_{0.5}Ti_{1.5}(PO₄)₃) containing Li, Al, Ti, P and O. Examples of the garnet-type oxide can include oxides (such as Li₇La₃Zr₂O₁₂) containing Li, La, Zr and O. Examples of the perovskite-type oxide can include oxides (such as LiLaTiO₃) containing Li, La, Ti and O.

(Electrode Active Material)

The electrode active material is a negative electrode active material when the solid-state cell electrode manufactured using the electrode material mixture slurry is a negative electrode, and likewise, the electrode active material is a positive electrode active material when the solid-state cell electrode is a positive electrode.

[Negative Electrode Active Material]

The negative electrode active material is not particularly limited as long as the negative electrode active material can absorb and release Li ions serving as a charge transfer medium, and examples thereof can include lithium transition metal oxides such as lithium titanate (Li₄Ti₅O₁₂), transition metal oxides such as TiO₂, Nb₂O₃ and WO₃, a metal sulfide, a metal nitride, graphite, carbon materials such as soft carbon and hard carbon, lithium metal, indium metal, a lithium alloy, silicon oxide, silicon and the like. The negative electrode active material may be in the form of powder or may be in the form of a thin film.

For example, the surface of the negative electrode active material is preferably coated with an oxide such as LiNbO₃. In this way, the decomposition of the negative electrode active material by the binder or the solvent is suppressed. An oxide coating layer formed of an oxide such as LiNbO₃ functions as a reaction suppression layer for suppressing a reaction between the negative electrode active material and the binder or the solvent.

For example, the coating using the reaction suppression layer is performed as follows. A precursor solution of the reaction suppression layer is first prepared. For example, LiOC₂H₅ is dissolved in an ethanol solvent such that a predetermined amount of ethoxylithium (LiOC₂H₅) and a predetermined amount of pentaethoxyniobium (Nb(OC₂H₅)₅) are included in ethanol, and then Nb(OC₂H₅)₅ is added to be dissolved, with the result that the precursor solution of the LiNbO₃ reaction suppression layer is prepared.

Then, the negative electrode active material is coated with the precursor solution of the LiNbO₃ reaction suppression layer. The coating is performed with, for example, a rolling flow coating device. The particles of Li_{1.15}Ni_{0.33}Co_{0.33}Mn_{0.33}O₂ which are a lithium transition metal composite oxide are put into the rolling flow coating device, and the precursor solution is sprayed while the negative electrode active material is being floated up by dry air to be circulated within the rolling flow coating device, with the result that the negative electrode active material coated with the precursor of the LiNbO₃ reaction suppression layer is obtained.

Then, the negative electrode active material coated with the precursor of the LiNbO₃ reaction suppression layer is subjected to heat treatment in an electric furnace in the atmosphere, and thus the negative electrode active material coated with the LiNbO₃ reaction suppression layer is obtained.

The surface of the negative electrode active material in the present embodiment is preferably modified by the surface modifier which will be described later regardless of whether the surface is coated with the reaction suppression layer. It is more preferable that the surface of the negative electrode active material coated with the reaction suppression layer is modified by the surface modifier.

[Positive Electrode Active Material]

Although the positive electrode active material is not particularly limited, examples thereof can include a Li-containing layered active material, a spinel-type active material, an olivine-type active material and the like. Specific examples of the positive electrode active material can include: lithium cobaltate (LiCoO₂); lithium nickelate (LiNiO₂); LiNiₚMn_{q}CoᵣO₂ (p+q+r=1); LiNiₚAl_{q}CoᵣO₂ (p+q+r=1); lithium manganate (LiMn₂O₄); a heterogeneous element-substituted Li—Mn spinel represented by Li₁+xMn₂−x−yMyO₄ (x+y=2, M=at least one type selected from Al, Mg, Co, Fe, Ni and Zn); lithium metal phosphate (LiMPO₄, M=at least one type selected from Fe, Mn, Co and Ni); and the like.

As in the negative electrode active material described above, the surface of the positive electrode active material in the present embodiment is preferably coated with an oxide such as LiNbO₃ to form a reaction suppression layer. A method for coating the positive electrode active material with the reaction suppression layer is preferably performed by the same method as for the negative electrode active material.

The surface of the positive electrode active material in the present embodiment is preferably modified by the surface modifier which will be described later regardless of whether the surface is coated with the reaction suppression layer. It is more preferable that the surface of the positive electrode active material coated with the reaction suppression layer is modified by the surface modifier.

(Binder)

The binder functions as a binding agent or a thickener in the electrode layer. In addition, the binder uniformizes the electrode material mixture slurry and further provides an appropriate viscosity. The binder is at least one of a polymer binder which includes an unsaturated carbon-carbon bond and a polymer binder which includes an electron donating group. In this way, when the electrode layer is formed of the electrode material mixture, the unsaturated carbon-carbon bond in the polymer binder including an unsaturated carbon-carbon bond chemically reacts with, for example, sulfur (S) in the solid electrolyte to form a covalent bond. Alternatively, a coordinate bond is formed between the electron donating group in the polymer binder including an electron donating group and, for example, lithium ions (Li⁺). In this way, it is possible to enhance the mechanical strength of the electrode layer formed of the electrode material mixture slurry.

Although the polymer binder including an unsaturated carbon-carbon bond is not particularly limited, examples thereof can include styrene-butadiene rubber, styrene-isoprene rubber and the like. Although the polymer binder including an electron donating group is not particularly limited, examples thereof can include hydrogenated nitrile butadiene rubber, an ethylene vinyl acetate copolymer, an ethylene methyl methacrylate copolymer, a styrene methyl methacrylate copolymer, a styrene n-dodecyl acrylate copolymer and the like. The electron donating group is preferably at least one functional group selected from the group consisting of an ester group, a carboxylate group, a sulfonate group, a nitrile group, an ether group and a phosphate group. It should be noted that the polymer binder including an electron donating group also functions as the surface modifier (copolymer) which will be described later. As the binder, one or a plurality of types can be combined to be used.

The polymer binder including an unsaturated carbon-carbon bond is preferably modified by the solvent or the surface modifier which will be described later. In this way, an affinity based on intermolecular interactions between the binder and the solid electrolyte and the electrode active material is enhanced, and thus it is possible to uniformize the electrode material mixture slurry.

The content of the binder in the entire electrode material mixture slurry which has been dried is preferably equal to or less than 5% by mass and more preferably equal to or less than 1.0% by mass. When the content is equal to or less than 5% by mass, the binding of the electrode active material, the solid electrolyte and a conductive aid to the binder and a current collector is sufficiently strong. In the electrode material mixture slurry, the binder is preferable to provide an appropriate viscosity, as well as stability and uniformity.

(Solvent)

The solvent used in the present invention is not particularly limited as long as the solvent is a non-polar, low-polar or medium-polar organic solvent whose boiling point is in a range of 70 to 220° C., and the solvent may be selected as necessary according to the properties of the electrode active material, the solid electrolyte and the like. In this case, being non-polar indicates that a Snyder's polarity parameter (or a Rohrschneider's polarity parameter) P′ value is −0.2≤P′<1.0, being low-polar indicates that the polarity parameter P′ value is 1.0≤P′<2.5 and being medium-polar indicates that the polarity parameter P′ value is 1.0≤P′<5.5. Examples of the solvent which can be preferably used can include aliphatic hydrocarbons, aromatic hydrocarbons, esters, ethers, ketones, nitriles and the like. When the solvent as described above is used, an affinity based on intermolecular interactions between the surface modifier and the binder is provided, with the result that the slurry of the composition is uniformized and stabilized. In addition, among surface modifiers which will be described later, a low-molecular compound is preferably used as the solvent. In this case, the surface modifier described above functions both as the solvent for dispersing or dissolving the electrode active material, the solid electrolyte and the binder and as the surface modifier for modifying the surface of at least any one of the electrode active material, the solid electrolyte, or the binder.

(Surface Modifier)

The electrode material mixture slurry according to the present embodiment preferably includes the surface modifier. The surface modifier is a material which modifies the surface of at least one of the electrode active material or the solid electrolyte included in the electrode material mixture slurry. In this way, at least one of the electrode active material or the solid electrolyte is suppressed to be decomposed by the binder or the solvent. Furthermore, an affinity between the electrode active material and the solid electrolyte and the binder and the solvent is enhanced, and this contributes to the uniformity and stability of the electrode material mixture slurry.

[Copolymer]

The surface modifier is preferably a copolymer which includes a predetermined functional group. The copolymer is used as the surface modifier, and thus distances between components of the electrode material mixture slurry are made constant to form a satisfactory interface, with the result that it is possible to enhance adhesion. The predetermined functional group is preferably at least one functional group selected from the group consisting of an ester group, a carboxylate group, a sulfonate group, a nitrile group, an ether group and a phosphate group. It should be noted that the polymer binder including an electron donating group may be used as the copolymer serving as the surface modifier. In other words, the polymer binder including an electron donating group also functions as the surface modifier, and these may be the same material.

Although the main chain skeleton of the copolymer is not particularly limited, examples thereof can include a copolymer which is obtained by polymerizing a radically polymerizable monomer. Examples of the monomer described above can include (meth)acrylic monomers, (meth)acrylamide monomers, styrene monomers, vinyl monomers and the like.

The content of a repeating unit including the predetermined functional group in the copolymer is preferably less than 10 mol %. In a case where a low-polar group and a polar group simultaneously exist in the copolymer, when a ratio of the repeating unit including the predetermined functional group contained in the copolymer is equal to or greater than 10 mol %, it is conceivable that microlayer separation of the copolymer itself may occur. This may lower the uniformity of the electrode material mixture slurry and inhibit the acquisition of the electrode material mixture slurry having an appropriate viscosity. When the content of the repeating unit including the predetermined functional group in the copolymer is set less than 10 mol %, the problem described above can be avoided. The content of the repeating unit including the predetermined functional group in the copolymer is more preferably equal to or greater than 1 mol % and less than 8 mol %, and further preferably equal to or greater than 2 mol % and less than 5 mol %.

The content of the copolymer in the entire electrode material mixture slurry which has been dried is preferably equal to or less than 5% by mass and more preferably equal to or less than 1.0% by mass.

(Low-Molecular Compound)

In addition to the copolymer described above, a low-molecular compound may be included as the surface modifier. The low-molecular compound is at least one selected from the group consisting of a carboxylate, a thiocarboxylate, a carboxylic acid, a thiocarboxylic acid, a phosphate ester, a thiophosphate ester, ketone, nitrile, alcohol, thiol and ether. Specifically, as the surface modifier (low-molecular compound), at least one compound selected from the group represented by the following structural formulae can be used. In the following structural formulae (1), each of R, R′ and R″ represents a carbon chain, X represents an oxygen atom or a sulfur atom and Li represents lithium. One type of these low-molecular compounds may be used singly or two or more types thereof may be used together.

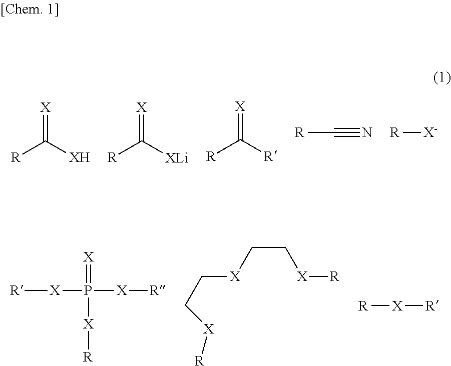

Since an alkyl chain is an insulator and does not conduct ions, each of R, R′ and R″ preferably includes a carbon chain having 1 to 11 carbons and more preferably includes a carbon chain having 1 to 6 carbons. Each of R, R′ and R″ further preferably includes a carbon chain having 1 to 4 carbons. When each of R, R′ and R″ is an aliphatic group, the aliphatic group is not limited to being linear, may be branched or cyclic and may be a saturated aliphatic group or an unsaturated aliphatic group. Each of R, R′ and R″ is preferably a saturated aliphatic group. In the carbon chain, a heteroatom may also be contained between carbon-carbon bonds. Furthermore, in the carbon chain, a substituent may or may not be provided. When each of R, R′ and R″ is an aromatic group, the aromatic group may be either a phenyl group or a naphthyl group. In the aromatic group, a heteroatom may also be contained between carbon-carbon bonds. Furthermore, in the aromatic group, a substituent may or may not be provided.

The surface modifier (low-molecular compound) selected from the structural formulae is preferably at least one selected from the group consisting of lithium butyrate, lithium isobutyrate, lithium acetate, butyl phosphate ester and isobutyronitrile.

The content of the surface modifier (low-molecular compound) in the electrode material mixture slurry which has been dried is preferably equal to or less than 3% by mass. The content is more preferably equal to or less than 1% by mass and further preferably equal to or less than 0.5% by mass. Preferably, when the content is equal to or less than 3% by mass, the decomposition of at least one of the electrode active material or the solid electrolyte by the binder or the solvent is suppressed, and this contributes to the uniformity and stability of the electrode material mixture slurry.

Each of the functional group included in the surface modifier selected from the structural formulae modifies, with the surface modifier, the surface of at least one of the electrode active material or the solid electrolyte, and thus the surface of the electrode active material or the solid electrolyte is converted to a surface having a carbon chain. In this way, at least one of the electrode active material and the solid electrolyte has an affinity for the solvent, the binder or the like caused by intermolecular interactions so as not to be easily decomposed. Since an affinity is enhanced by intermolecular interactions such as a hydrophobic interaction, π-π stacking, a hydrophilic interaction and electrostatic interactions (such as a hydrogen bond and a van der Waals force) exerted between the electrode active material, the solid electrolyte, the solvent and the binder, it is estimated that the electrode material mixture slurry and the solid electrolyte slurry are uniformized and stabilized. Since these intermolecular interactions also act on other components such as a conductive aid which can be applied to the solid-state cell, even when the electrode material mixture and the solid electrolyte composition include the conductive aid, an affinity is maintained, and the electrode material mixture slurry and the solid electrolyte slurry are uniformized and stabilized.

(Other Components)

The electrode material mixture slurry according to the present invention may optionally include known components other than those described above which can be used when the electrode layer of the solid-state cell is formed without inhibiting the effects of the present invention. For example, a conductive aid may be included. Examples of the conductive aid can include acetylene black, natural graphite, artificial graphite and the like. In addition, as a binder other than the binder including an unsaturated carbon-carbon bond, a known component which functions as a binding agent or a thickener and is used as a binder for the solid-state cell may be included.

(Method for Preparing Electrode Material Mixture Slurry)

For example, the electrode material mixture slurry can be obtained by a step of dispersing at least one of the electrode active material or the solid electrolyte in a solvent in which the surface modifier is dissolved or dispersed and modifying the surface of at least one of the electrode active material or the solid electrolyte and a step of mixing the mixture obtained in the step described above, a binder solution obtained by dispersing the binder in a solvent as necessary and other components such as a conductive aid. In the step of modifying the surface, the surface modifier which is the low-molecular compound can also be used as the solvent. For the mixing and dispersing described above, various types of mixing/dispersing devices such as an ultrasonic disperser, a shaker and Filmix (registered trademark) can be used.

### Solid-State Cell Electrode

The solid-state cell electrode (negative and positive electrodes) according to the present embodiment can be obtained by applying the electrode material mixture slurry described above to the surface of the current collector and drying the electrode material mixture slurry to form the electrode layer on the current collector. In this way, a covalent bond is formed between the binder included in the electrode material mixture slurry and at least one of the solid electrolyte or the electrode active material.

(Current Collector)

A positive electrode current collector is not particularly limited, examples thereof can include aluminum, an aluminum alloy, stainless steel, nickel, iron, titanium and the like, and among them, aluminum, an aluminum alloy and stainless steel are preferable. Examples of the shape of the positive electrode current collector can include a foil shape, a plate shape, a porous shape and the like.

A negative electrode current collector is not particularly limited, and examples thereof can include nickel, copper, stainless steel and the like. Examples of the shape of the negative electrode current collector can include a foil shape, a plate shape, a porous shape and the like.

(Method for Forming Electrode Layer)

As a method for forming the electrode layer, a known method of applying the electrode material mixture slurry described above to the surface of the current collector and drying the electrode material mixture slurry can be used, and one of a wet method and a dry method may be adopted. A case where the electrode layer is formed by the wet method will be described below.

The electrode layer is manufactured by a step of applying the electrode material mixture slurry to the surface of the current collector and drying the electrode material mixture slurry to form the electrode layer on the surface of the current collector. A method for applying the electrode material mixture slurry to the surface of the current collector is not particularly limited, an inkjet method, a screen printing method, a CVD method, a sputtering method and the like can be used and a known application unit such as a doctor blade may be used. Although the total thickness (thickness of the electrode) of the electrode layer and the current collector which have been dried is not particularly limited, for example, in terms of energy density and stackability, the total thickness is preferably equal to or greater than 0.1 μm and equal to or less than 1 mm and more preferably equal to or greater than 1 μm and equal to or less than 200 μm. The electrode may be produced through an optional pressing process. A pressure when the electrode is pressed can be set to about 100 MPa.

### Solid-State Cell

The solid-state cell including the solid-state cell electrode includes the negative electrode, the positive electrode and a solid electrolyte layer. The negative electrode is formed with the negative electrode current collector and a negative electrode layer, and the positive electrode is formed with the positive electrode current collector and a positive electrode layer. The solid electrolyte layer is arranged between the negative electrode layer and the positive electrode layer. The number of layers in the negative electrode, the positive electrode and the solid electrolyte layer is not particularly limited, and a plurality of negative electrodes, positive electrodes and solid electrolyte layers may be stacked. In this case, the layers are arranged such that the solid electrolyte layer is arranged between the negative electrode and the positive electrode.

(Solid Electrolyte Layer)

The solid electrolyte layer is stacked between the negative electrode layer and the positive electrode layer, and contains at least a solid electrolyte material. A charge transfer medium can be conducted between the negative electrode active material and the positive electrode active material through the solid electrolyte material included in the solid electrolyte layer. As the solid electrolyte material which can be used for the solid electrolyte layer, the solid electrolyte material described previously can be preferably used.

In a method for forming the solid electrolyte layer, the solid electrolyte layer can be produced through, for example, a step of pressing the solid electrolyte. The solid electrolyte layer can also be produced through a process of applying a solid electrolyte slurry solution prepared by dispersing the solid electrolyte material and the like in a solvent to the surface of a base material or the electrode. In the manufacturing of the solid electrolyte layer, the surface of the solid electrolyte may be chemically modified in a solvent in which the surface modifier is dispersed. In this case, the surface of the solid electrolyte can be chemically modified by the same procedure as that for the electrode layer. Although the thickness of the solid electrolyte layer is significantly different depending on the configuration of the cell, for example, the thickness is preferably equal to or greater than 0.1 μm and equal to or less than 1 mm and more preferably equal to or greater than 1 μm and equal to or less than 100 μm.

(Method for Manufacturing Solid-State Cell)

A method for manufacturing the solid-state cell is not particularly limited, a known method can be applied and examples thereof can include a method of stacking the negative electrode, the solid electrolyte layer and the positive electrode in this order and optionally pressing and integrating the stack.

The present invention is not limited to the embodiment described above, and variations and modifications which can achieve the object of the present invention are included in the present invention.

### EXAMPLES

Although Examples of the present invention will then be described, the present invention is not limited to Examples below.

### Example 1

(Preparation of Binder Solution)

Styrene-butadiene rubber (A-1, chemical formula (2) below) serving as a binder: In a glove box filled with argon gas, styrene-butadiene rubber (butadiene content of 90 mol %, moisture content<20 mass ppm) was dissolved in n-butyl n-butyrate (moisture concentration<20 ppm), with the result that a 10 mass % binder solution was prepared.

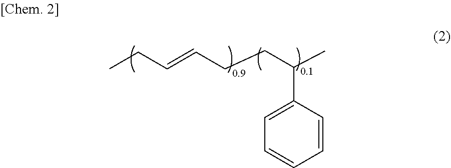

(Production of Positive Electrode) 6.7 g of a nickel-manganese-cobalt ternary positive electrode active material (LiNi_{0.8}Mn_{0.1}Co_{0.1}O₂) the surface of which was coated with LiNbO₃ was used as a positive electrode active material, and 3.0 g of a Li—P—S—Cl-based solid electrolyte, 0.2 g of acetylene black and 1 g of the 10 mass % n-butyl n-butyrate solution of the styrene-butadiene rubber binder were mixed with n-butyl n-butyrate, with the result that a slurry was prepared. The slurry was applied to a current collector foil with an automatic bar coater, and thus a positive electrode layer was obtained.

(Production of Negative Electrode)

Production of negative electrode: 6.9 g of graphite was used as a negative electrode active material, and 3.0 g of the Li—P—S—Cl-based solid electrolyte and 1 g of the 10 mass % n-butyl n-butyrate solution of the styrene-butadiene rubber binder were mixed with n-butyl n-butyrate, with the result that a slurry was prepared. The slurry was applied to a current collector foil with the automatic bar coater, and thus a negative electrode was obtained.

(Production of Solid Electrolyte Layer)

9.9 g of the Li—P—S—Cl-based solid electrolyte and 1 g of the 10 mass % n-butyl n-butyrate solution of the styrene-butadiene rubber binder were mixed with n-butyl n-butyrate, with the result that a slurry was prepared. The slurry was applied to a PET film with the automatic bar coater, the PET film was separated after being dried, with the result that a solid electrolyte layer was obtained.

[TOF-SIMS Analysis]

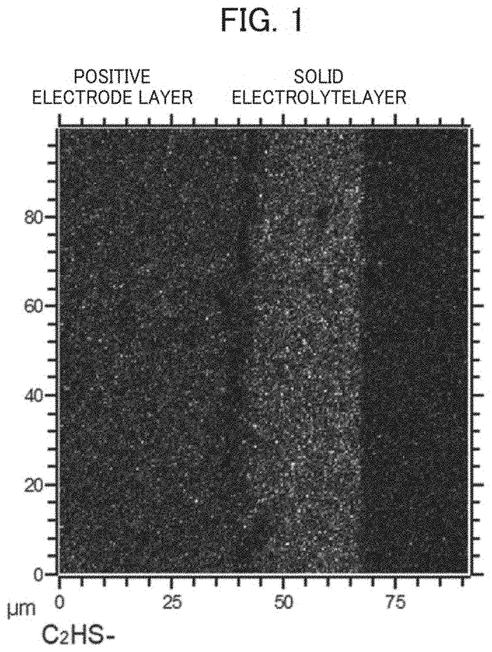

The electrode layer and the solid electrolyte layer which were produced were stacked and were analyzed by TOF-SIMS (TOFSIMS.5 made by IONTOF GmbH), a negative ion fragment C₂HS⁻ component was confirmed and it was confirmed that the C═C double bond of the binder had bonded with the sulfur atom of the solid electrolyte. The results are shown in FIG. 1.

### Example 2

A positive electrode layer, a negative electrode layer and a solid electrolyte layer were produced in the same manner as in Example 1 except that instead of the styrene-butadiene rubber in Example 1, hydrogenated nitrile butadiene rubber (acrylonitrile content of 10 mol %, moisture content<20 mass ppm) represented by chemical formula (3) below was used.

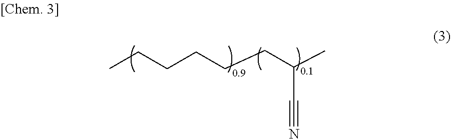

[IR Analysis]

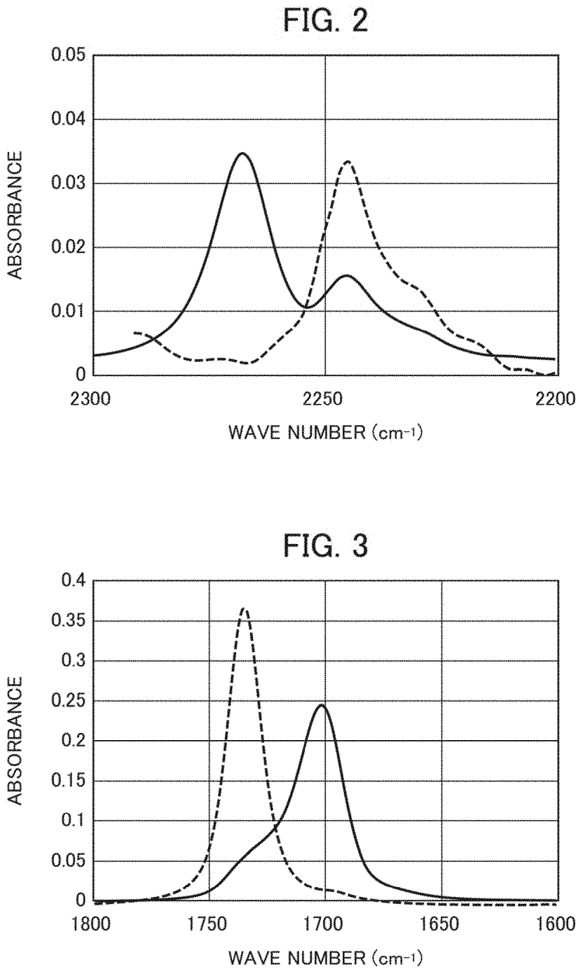

The electrode layer which was produced was analyzed with an IR analyzer (TENSOR37 made by Bruker Corporation), and consequently, a shift of a C≡N bond in a polymer binder was observed and it was confirmed that a C≡N group had coordinated with lithium ions in the solid electrolyte. The results are shown in FIG. 2. A broken line in FIG. 2 represents an IR spectrum before the binder was mixed with the solid electrolyte, and a solid line in FIG. 2 represents an IR spectrum after the binder was mixed with the solid electrolyte.

### Example 3

A positive electrode layer, a negative electrode layer and a solid electrolyte layer were produced in the same manner as in Example 1 except that instead of the styrene-butadiene rubber in Example 1, an ethylene vinyl acetate copolymer (vinyl acetate content of 12 mol %, moisture content<20 mass ppm) represented by chemical formula (4) below was used.

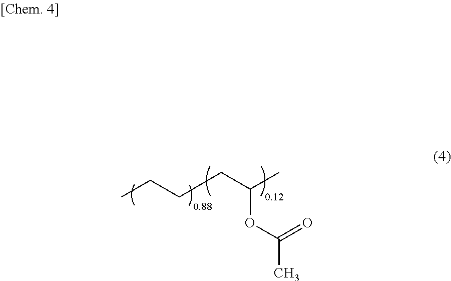

### Example 4

A positive electrode layer, a negative electrode layer and a solid electrolyte layer were produced in the same manner as in Example 1 except that instead of the styrene-butadiene rubber in Example 1, an ethylene methyl methacrylate copolymer (methyl methacrylate content of 10 mol %, moisture content<20 mass ppm) represented by chemical formula (5) below was used.

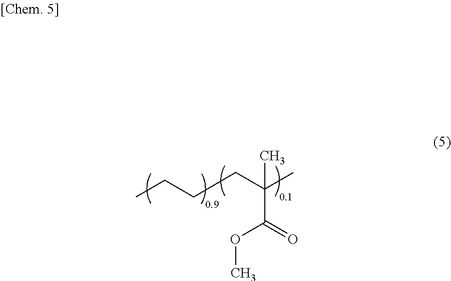

[IR Analysis]

The electrode layer which was produced was analyzed with the IR analyzer (TENSOR37 made by Bruker Corporation), and consequently, a shift of a C≡O bond in a polymer binder was observed and it was confirmed that a C≡O group had coordinated with lithium ions in the solid electrolyte. The results are shown in FIG. 3. A broken line in FIG. 3 represents an IR spectrum before the binder was mixed with the solid electrolyte, and a solid line in FIG. 3 represents an IR spectrum after the binder was mixed with the solid electrolyte.

### Example 5

A positive electrode layer, a negative electrode layer and a solid electrolyte layer were produced in the same manner as in Example 1 except that instead of the styrene-butadiene rubber in Example 1, a styrene methyl methacrylate copolymer (methyl methacrylate content of 15 mol %, moisture content<20 mass ppm) represented by chemical formula (6) below was used.

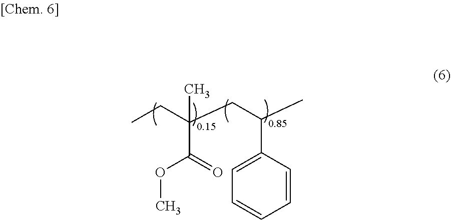

### Example 6

A positive electrode layer, a negative electrode layer and a solid electrolyte layer were produced in the same manner as in Example 1 except that instead of the styrene-butadiene rubber in Example 1, a styrene n-dodecyl acrylate copolymer (n-dodecyl acrylate content of 25 mol %, moisture content<20 mass ppm) represented by chemical formula (7) below was used.

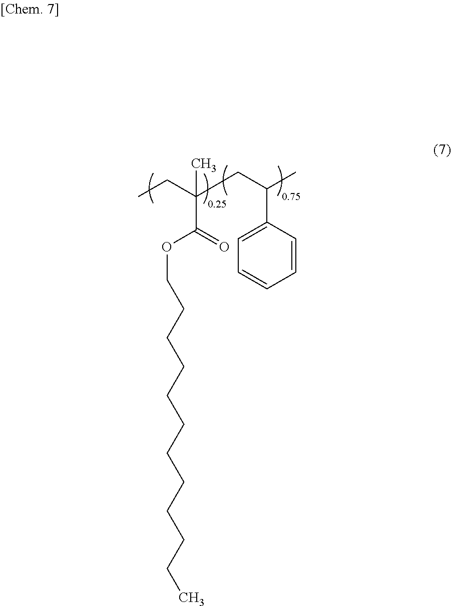

### Example 7

A positive electrode layer, a negative electrode layer and a solid electrolyte layer were produced in the same manner as in Example 1 except that instead of the styrene-butadiene rubber in Example 1, a styrene maleate dimethyl copolymer (maleate dimethyl content of 5 mol %, moisture content<20 mass ppm) represented by chemical formula (8) below was used.

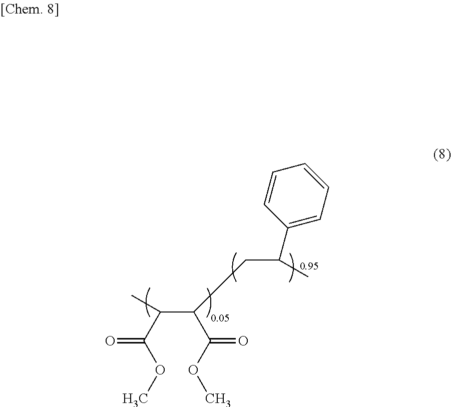

### Comparative Example 1

A positive electrode layer, a negative electrode layer and a solid electrolyte layer were produced in the same manner as in Example 1 except that instead of the styrene-butadiene rubber in Example 1, a hydrogenated styrene butadiene copolymer (styrene content of 10 mol %, moisture content<20 mass ppm) represented by chemical formula (9) below was used.

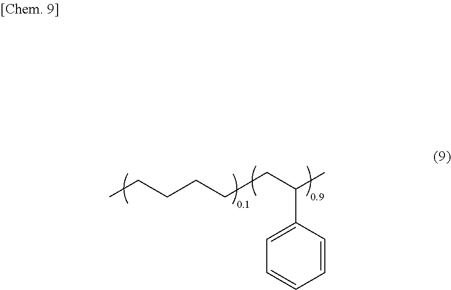

### Comparative Example 2

A positive electrode layer, a negative electrode layer and a solid electrolyte layer were produced in the same manner as in Example 1 except that instead of the styrene-butadiene rubber in Example 1, polyisobutene (moisture content<20 mass ppm) represented by chemical formula (10) below was used.

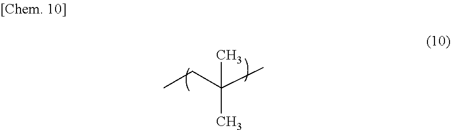

(Production of Positive Electrode Half-Cell)

The positive electrode and the solid electrolyte layer in each of Examples and Comparative Examples were used, a positive electrode sheet punched into a 10 mm diameter circle in a 10 mm inner diameter ceramic tube, the solid electrolyte and an indium-lithium alloy counter electrode were arranged and press molding was performed, with the result that a cell was produced. In this case, the alloy counter electrode functions as the negative electrode.

(Production of Negative Electrode Half-Cell)

The negative electrode and the solid electrolyte layer in each of Examples and Comparative Examples were used, a negative electrode sheet punched into a 10 mm diameter circle in a 10 mm inner diameter ceramic tube, the solid electrolyte and an indium-lithium alloy counter electrode were arranged and press molding was performed, with the result that a cell was produced. In this case, the alloy counter electrode functions as the positive electrode.

[Evaluations]

The positive electrode half-cell and the negative electrode half-cell in each of Examples and Comparative Examples which were produced as described above were used, and thus a cell capacity was measured. The charge/discharge conditions of the cell were 25° C. and a charge/discharge rate of 0.1 c. A charge/discharge cycle was repeated, and a discharge capacity at the fifth cycle was defined as the cell capacity. A value obtained by dividing the cell capacity by the weight of an electrode active material was defined as a capacity mAh/g per unit weight. The results are shown in Table 1.

TABLE 1

| | | | Functional | Positive | Negative |
|---|---|---|---|---|---|
| | | | group | electrode | electrode |
| | | Functional | content | capacity | capacity |
| | Binder type | group type | (mol %) | (mAh/g) | (mAh/g) |
| Example 1 | Styrene- | Butadiene group | 90 | 205 | 321 |
| | butadiene rubber | | | | |
| Example 2 | Hydrogenated | Nitrile group | 10 | 198 | 319 |
| | nitrile | | | | |
| | butadiene rubber | | | | |
| Example 3 | Ethylene | Vinyl acetate | 12 | 195 | 318 |
| | vinyl acetate | group | | | |
| | copolymer | | | | |
| Example 4 | Ethylene methyl | Methyl | 10 | 193 | 315 |
| | methacrylate | methacrylate | | | |
| | copolymer | group | | | |
| Example 5 | Styrene methyl | Methyl | 15 | 191 | 315 |
| | methacrylate | methacrylate | | | |
| | copolymer | group | | | |
| Example 6 | Styrene n- | N-dodecyl | 25 | 190 | 310 |
| | dodecyl acrylate | acrylate group | | | |
| | copolymer | | | | |
| Example 7 | Styrene | Dimethyl | 5 | 190 | 310 |
| | dimethyl maleate | maleate group | | | |
| | copolymer | | | | |
| Comparative | Hydrogenated | Styrene group | 90 | 150 | 250 |
| Example 1 | styrene | | | | |
| | butadiene rubber | | | | |
| Comparative | Polyisobutene | — | — | 130 | 200 |
| Example 2 | | | | | |

It has been confirmed from the results of Table 1 that the solid-state cell according to each of Examples had a higher positive electrode capacity and a higher negative electrode capacity (mAh/g) than the solid-state cell according to each of Comparative Examples.

What is claimed is:

1. An electrode material mixture slurry for manufacturing a solid-state cell electrode, the electrode material mixture slurry comprising:
a solid electrolyte, an electrode active material, a binder, and a solvent,
the solid electrolyte being at least one of a sulfide or an oxide,
the binder being at least one of a polymer binder that comprises an unsaturated carbon-carbon bond or a polymer binder that comprises an electron donating group.

2. The electrode material mixture slurry according to claim 1, further comprising a surface modifier that modifies a surface of at least one of the solid electrolyte or the electrode active material.

3. The electrode material mixture slurry according to claim 2, wherein the surface modifier is a copolymer, and
in the copolymer, a content of a repeating unit comprising a predetermined functional group is less than 10 mol %.

4. The electrode material mixture slurry according to claim 3, wherein the copolymer is used as the binder.

5. The electrode material mixture slurry according to claim 3, wherein in the copolymer, the content of the repeating unit including a predetermined functional group is equal to or greater than 1 mol % and less than 8 mol %.

6. The electrode material mixture slurry according to claim 5, wherein in the copolymer, the content of the repeating unit comprising a predetermined functional group is equal to or greater than 2 mol % and less than 5 mol %.

7. The electrode material mixture slurry according to claim 3, wherein the predetermined functional group is at least one functional group selected from the group consisting of an ester group, a carboxylate salt group, a sulfonate salt group, a nitrile group, an ether group, and a phosphate salt group.

8. A solid-state cell electrode comprising: an electrode layer that includes a solid electrolyte, an electrode active material, and a binder,
the binder being at least one of a polymer binder that includes an unsaturated carbon-carbon bond or a polymer binder that includes an electron donating group,
the solid electrolyte being at least one of a sulfide or an oxide,
the electrode layer comprising a covalent bond or a coordinate bond formed between the binder and at least one of the solid electrolyte or the electrode active material.

9. A solid-state cell comprising the solid-state cell electrode according to claim 8.
